(19) United States
(12) Patent Application Publication
(10) Pub. No.: US 2024/0043153 A1
(43) Pub. Date: Feb. 8, 2024

(54) SEALING DEVICE, DEVICE FOR PRODUCING POLYCRYSTALLINE SILICON FILLER, AND METHOD FOR PRODUCING POLYCRYSTALLINE SILICON FILLER

(71) Applicant: TOKUYAMA CORPORATION, Yamaguchi (JP)

(72) Inventors: Yasuhiro MIZUTANI, Yamaguchi (JP); Takahisa IMAI, Yamaguchi (JP); Masami FUJII, Yamaguchi (JP); Kazuhiro KAWAGUCHI, Yamaguchi (JP)

(21) Appl. No.: 18/286,267

(22) PCT Filed: Mar. 25, 2022
(86) PCT No.: PCT/JP2022/014352

§ 371 Date: Oct. 10, 2023

(30) Foreign Application Priority Data
Apr. 28, 2021 (JP) 2021-076814

(51) Int. Cl. B65B 51/14; B65B 7/06

(52) U.S. Cl. CPC B65B 51/146; B65B 7/06

(57) ABSTRACT

In order to reduce, at the time when an opening of an accommodation bag is sealed, wrinkles that occur at the accommodation bag, a sealing device (1) includes: a contact member (10) configured to be inserted into an accommodation bag (B1) accommodating a polycrystalline silicon material (S1); a sealing member configured to seal a sealing area (SE); a driving mechanism (20) configured to drive the contact member (10) so as to pull an opening (B2); and a sandwiching member (30) configured to be able to sandwich the accommodation bag (B1) for a second distance (D2) shorter than a first distance (D1) that is a length of the accommodation bag (B1) along the opening (B2) of the accommodation bag (B1).

### TECHNICAL FIELD

The present invention relates to a sealing device, an apparatus for producing a polycrystalline silicon material package, and a method for producing a polycrystalline silicon material package.

### BACKGROUND ART

Patent Literature 1 discloses a method for packaging a polycrystalline silicon material into a packaging bag. In the method for packaging a polycrystalline silicon material disclosed in Patent Literature 1, after a polycrystalline silicon material is packed in a packaging bag, sandwiching rods sandwich therebetween an area that is closer to a packing part in which the polycrystalline silicon material is packed than to a planned welding-seal part for sealing the packaging bag through welding. Subsequently, in a state where the area of the packaging bag is sandwiched by the sandwiching rods, the planned welding-seal part is sandwiched by sealing rods and welded.

### CITATION LIST

### Patent Literature

[Patent Literature 1]
Publication of International Publication No. WO 2019/203316

### SUMMARY OF INVENTION

### Technical Problem

In the method for packaging a polycrystalline silicon material disclosed in Patent Literature 1, the planned welding-seal part is welded in a state where the area of the packaging bag is sandwiched by the sandwiching rods. However, the following problem is present in the method. That is, the sandwiching rods have a length that covers an entire length of the packaging bag along an opening of the packaging bag. Thus, in the packaging method, an air-filled space is formed between the sealing rods located at higher positions and the sandwiching rods, and, due to a bulge caused by the air-filled space, wrinkles unfortunately occur in a region of the packaging bag which is around the bulge and which includes the planned welding-seal part. It is an object of an aspect of the present invention to reduce, at the time when an opening of the accommodation bag is sealed, wrinkles that occur in an accommodation bag.

### Solution to Problem

In order to solve the foregoing problem, a sealing device in accordance with an aspect of the present invention for a polycrystalline silicon material accommodation bag includes: a contact member configured to be inserted from above into an opening of an accommodation bag accommodating a polycrystalline silicon material and configured to be brought into contact with an inner surface of the accommodation bag; a sealing member configured to seal a sealing area in the accommodation bag; a driving mechanism configured to drive the contact member inserted into the opening of the accommodation bag so as to pull at least two points of the opening in order to flatten the sealing area; and a sandwiching member configured to sandwich the accommodation bag at a position below the sealing area and configured to be able to sandwich the accommodation bag for a second distance shorter than a first distance that is a length of the accommodation bag along the opening of the accommodation bag in which the sealing area has been flattened by the driving mechanism.

A method in accordance with an aspect of the present invention for producing a polycrystalline silicon material package includes the steps of: inserting a contact member from above into an opening of an accommodation bag accommodating a polycrystalline silicon material and bringing the contact member into contact with an inner surface of the accommodation bag; driving the contact member inserted into the opening of the accommodation bag so as to pull at least two points of the opening in order to flatten a sealing area in the accommodation bag; sandwiching, with use of a sandwiching member, the accommodation bag at a position below the sealing area in the accommodation bag and for a second distance shorter than a first distance that is a length of the accommodation bag along the opening of the accommodation bag in which the sealing area has been flattened in the step of driving; and sealing the sealing area to make the accommodation bag into a package of the polycrystalline silicon material.

### Advantageous Effects of Invention

An aspect of the present invention makes it possible to reduce, at the time when an opening of an accommodation bag is sealed, wrinkles that occur in the accommodation bag.

### BRIEF DESCRIPTION OF DRAWINGS

FIG. 1 is a perspective view illustrating a configuration of a production apparatus in accordance with Embodiment 1 of the present invention for producing a polycrystalline silicon material package.

FIG. 2 is a front view illustrating a configuration of a sealing device which is for a polycrystalline silicon material accommodation bag and which is included in the production apparatus illustrated in FIG. 1.

FIG. 3 is a right side view illustrating the sealing device illustrated in FIG. 2.

FIG. 4 is a plan view illustrating the sealing device illustrated in FIG. 2.

FIG. 5 is a view illustrating a procedure of a method in accordance with Embodiment 1 of the present invention for producing a polycrystalline silicon material package.

FIG. 6 is a front view illustrating a configuration of a sealing device in accordance with Embodiment 2 of the present invention.

### DESCRIPTION OF EMBODIMENTS

### Embodiment 1

<Configuration of Apparatus for Producing Polycrystalline Silicon Material Package>

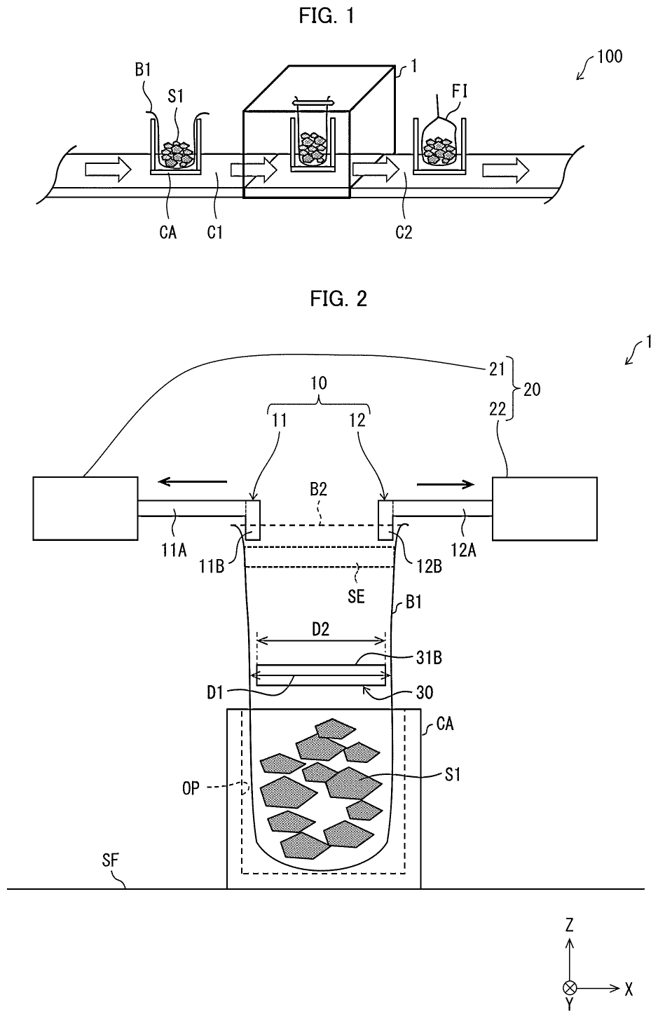

FIG. 1 is a perspective view illustrating a configuration of a production apparatus 100 in accordance with Embodiment 1 of the present invention for producing a polycrystalline silicon material package. The production apparatus 100 is configured to produce a polycrystalline silicon material package FI in which a polycrystalline silicon material S1 is packed. As illustrated in FIG. 1, the production apparatus 100 includes a sealing device 1, a conveyor C1, and a conveyor C2.

The conveyor C1 is configured to convey, to the sealing device 1, an accommodation case CA accommodating an accommodation bag B1 in which the polycrystalline silicon material S1 is packed. That is, the conveyor C1 is a carry-in section configured to carry in, to the sealing device 1, the accommodation bag B1 accommodating the polycrystalline silicon material S1.

The sealing device 1 is a device configured to seal the accommodation bag B1 accommodating the polycrystalline silicon material S1. The sealing device 1 will be described later in detail. The conveyor C2 is configured to carry, out of the production apparatus 100, the accommodation case CA accommodating the accommodation bag B1 that has been sealed by the sealing device 1. That is, the conveyor C2 is a discharge section configured to discharge, as the polycrystalline silicon material package FI, the accommodation bag B1 that has been sealed by the sealing device 1.

<Configuration of Sealing Device>

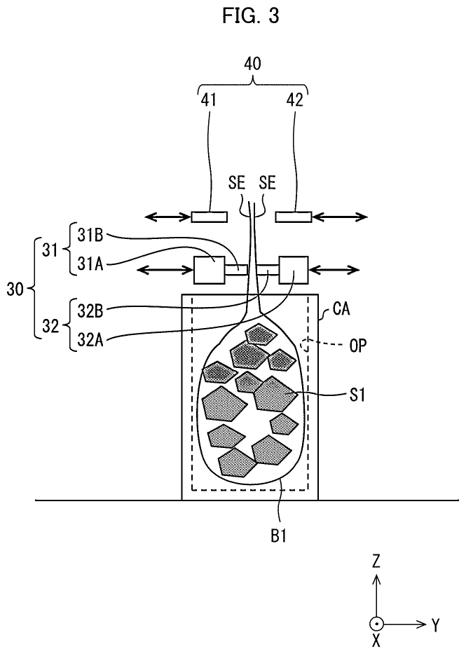

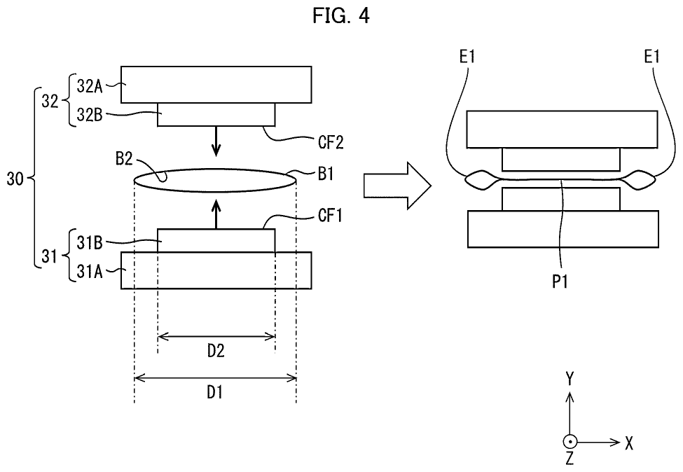

FIG. 2 is a front view illustrating a configuration of the sealing device 1 which is for a polycrystalline silicon material accommodation bag and which is included in the production apparatus 100 illustrated in FIG. 1. FIG. 3 is a right side view illustrating the sealing device 1 illustrated in FIG. 2. FIG. 4 is a plan view illustrating the sealing device 1 illustrated in FIG. 2.

Note that FIG. 2 omits a sealing member 40; FIG. 3 omits a contact member 10 and a driving mechanism 20; and FIG. 4 omits the accommodation case CA, the polycrystalline silicon material S1, the contact member 10, the driving mechanism 20, and the sealing member 40. Further, in FIGS. 2 to 4, an X-axis direction corresponds to a direction in which a first driving section 21 and a second driving section 22 are aligned, a Y-axis direction corresponds to a direction in which a first sandwiching member 31 and a second sandwiching member 32 are aligned, and a Z-axis direction corresponds to a direction perpendicular to a placement surface SF on which the accommodation case CA is placed.

As illustrated in FIGS. 2 and 3, the sealing device 1 includes the contact member 10, the driving mechanism 20, and a sandwiching member 30, and the sealing member 40. The sealing device 1 is configured to seal the accommodation bag B1 in which the polycrystalline silicon material S1 is accommodated and which is conveyed by the conveyor C1.

As illustrated in FIG. 2, the contact member 10 is configured to be inserted from above into an opening B2 of the accommodation bag B1 accommodating the polycrystalline silicon material S1 and is configured to be brought into contact with an inner surface of the accommodation bag B1. Specifically, for example, the contact member 10 includes a first jig 11 and a second jig 12 each of which is configured to be inserted from above into the opening B2 of the accommodation bag B1 and each of which is to be brought into contact with the inner surface of the accommodation bag B1.

The first jig 11 includes a first portion 11A and a second portion 11B. The first portion 11A is connected to the first driving section 21 described later and extends in the X-axis direction. The second portion 11B is connected to an end of the first portion 11A on a positive direction side of an X axis and extends in a negative direction of a Z axis.

The second jig 12 includes a first portion 12A and a second portion 12B. The first portion 12A is connected to the second driving section 22 described later and extends in the X-axis direction. The second portion 12B is connected to an end of the first portion 12A on a negative direction side of the X axis and extends in the negative direction of the Z axis.

The driving mechanism 20 drives the contact member 10 inserted into the opening B2 of the accommodation bag B1 so that at least two points of the opening B2 are pulled apart from each other, in order to flatten a sealing area SE of the accommodation bag B1. Specifically, for example, the driving mechanism 20 is configured to cause the first jig 11 and the second jig 12 to move apart from each other so as to pull both ends of the opening B2, so that the sealing area SE is flattened.

According to such a configuration, it is possible to reduce a bulge in an upper portion of the accommodation bag B1 and thus to discharge an unnecessary air in the accommodation bag B1 out of the accommodation bag B1. Further, it is possible to flatten the sealing area SE with a simple configuration of causing the first jig 11 and the second jig 12 to move. This makes it possible to reduce a cost of the sealing device 1.

In addition, the driving mechanism 20 includes the first driving section 21 and the second driving section 22. The first driving section 21 causes the first portion 11A to move in the X-axis direction. The second driving section 22 causes the first portion 12A to move in the X-axis direction. The first driving section 21 and the second driving section 22 move in the Z-axis direction.

Before the second portions 11B and 12B are inserted into the opening B2, the second portions 11B and 12B are located at an approximate center of the opening B2 in the X-axis direction and are in contact with each other. In this state, the first driving section 21 moves in the negative direction of the Z axis, so that the second portion 11B also moves in the negative direction of the Z axis to be inserted into the opening B2. Further, the second driving section 22 moves in the negative direction of the Z axis, so that the second portion 12B also moves in the negative direction of the Z axis to be inserted into the opening B2.

Further, the first driving section 21 causes the first portion 11A to move in a negative direction of the X axis, so that the second portion 11B is brought into contact with one end of the opening B2. The second driving section 22 causes the first portion 12A to move in a positive direction of the X axis, so that the second portion 12B is brought into contact with the other end of the opening B2. Further, from this state, the first driving section 21 causes the first portion 11A to move in the negative direction of the X axis by a predetermined distance while the second driving section 22 causes the first portion 12A to move in the positive direction of the X axis by a predetermined distance, so that the both ends of the opening B2 are pulled by the second portions 11B and 12B.

The sandwiching member 30 is configured to sandwich the accommodation bag B1 such that the accommodation bag B1 is sandwiched at a position below the sealing area SE. As illustrated in FIG. 3, the sandwiching member 30 includes the first sandwiching member 31 and the second sandwiching member 32. The first sandwiching member 31 includes a first support 31A and a first contact part 31B. As illustrated in FIG. 4, the first contact part 31B is fixed to the first support 31A and has a first contact surface CF1. The second sandwiching member 32 includes a second support 32A and a second contact part 32B. The second contact part 32B is fixed to the second support 32A and has a second contact surface CF2. The first contact part 31B and the second contact part 32B are each made of resin. The first contact surface CF1 and the second contact surface CF2 are each also made of resin.

According to such a configuration, it is possible to further reduce a bulge in the upper portion of the accommodation bag B1 and thus to discharge a larger amount of an unnecessary air in the accommodation bag B1 out of the accommodation bag B1, compared with a case where merely, the driving mechanism 20 pulls the both ends of the opening B2. In addition, it is also possible to further flatten the sealing area SE.

A second distance D2 which is a length of the first contact part 31B along the X-axis direction is shorter than a first distance D1 which is a length of the accommodation bag B1 along the opening B2 of the accommodation bag B1 in which the sealing area SE has been flattened by the driving mechanism 20. In addition, a length of the second contact part 32B along the X-axis direction is equal to the second distance D2. The sandwiching member 30 sandwiches the accommodation bag B1 with use of the first sandwiching member 31 and the second sandwiching member 32. In this case, the first contact surface CF1 and the second contact surface CF2 are brought into contact with an outer surface of the accommodation bag B1. Thus, the sandwiching member 30 is configured to be able to sandwich the accommodation bag B1 for the second distance D2.

As illustrated in FIG. 3, the sealing member 40 is configured to seal the sealing area SE of the accommodation bag B1. The sealing member 40 includes a first sealing member 41 and a second sealing member 42. The sealing member 40 seals the sealing area SE of the accommodation bag B1 from both a positive direction side of a Y axis and a negative direction side of the Y axis with use of the first sealing member 41 and the second sealing member 42.

The first sealing member 41 and the second sealing member 42 each contain a heater, and the sealing member 40 seals the sealing area SE by welding the sealing area SE with use of those heaters. The sealing area SE is flattened by the driving mechanism 20 and the sandwiching member 30. This makes it possible to improve accuracy with which the sealing member 40 seals the sealing area SE. That is, it is possible to improve sealing properties of the accommodation bag B1.

As described above, in the sealing device 1, the length (second distance D2) for which the sandwiching member 30 sandwiches the accommodation bag B1 is shorter than the length (first distance D1) of the accommodation bag B1 along the opening B2 of the accommodation bag B1. This makes it possible to allow an air to flow between a sandwiched portion P1 sandwiched by the sandwiching member 30 and each of outer ends E1 of the accommodation bag B1 in a state where the sandwiching member 30 sandwiches the accommodation bag B1, as illustrated in FIG. 4. Therefore, when the opening B2 of the accommodation bag B1 is sealed, it is possible to reduce wrinkles that occur in the accommodation bag B1.

In addition, assume a case where since an irregular-shape object such as the polycrystalline silicon material S1 is accommodated in the accommodation bag B1, unevenness at an outer peripheral portion of the accommodation bag B1 occurs and a shape of the accommodation bag B1 becomes irregular. Even in this case, it is possible to reduce wrinkles that occur in the accommodation bag B1. Further, it is possible to easily flatten the sealing area SE and to reduce the possibility that in a case where the accommodation bag B1 accommodates a mobile matter, displacement of the accommodation bag B1 itself may occur due to rolling and collapse of such a matter.

Furthermore, it is possible to reduce the risk of generation of an unsealed portion in the sealing area SE and thus to maintain the sealing properties of the accommodation bag B1, as compared with a case where the sealing area SE is sealed in a state where the accommodation bag B1 has wrinkles. This improves a sealing strength in the sealing area SE, and therefore it is possible to reduce the risk that an unclean air outside the accommodation bag B1 may enter the accommodation bag B1. This makes it possible to reduce the risk of affecting quality of the polycrystalline silicon material S1 which needs to be highly pure.

In addition, it is possible to reduce wrinkles that occur in the accommodation bag B1 and thus to prevent, for example, a protrusion of the polycrystalline silicon material S1 having an irregular shape from being stuck in the wrinkle of the accommodation bag B1. Therefore, it is possible to prevent an external force from being applied to the accommodation bag B1 in a state where the protrusion is stuck in the wrinkle of the accommodation bag B1. This consequently makes it possible to prevent the protrusion from breaking through the accommodation bag B1.

In addition, since it is possible to prevent the protrusion from being stuck in the wrinkle of the accommodation bag B1, it is thus possible to prevent, for example, the protrusion from scraping a wrinkle portion and the like of the accommodation bag B1. Thus, it is possible to prevent, for example, a risk that the accommodation bag B1 may have a weak portion and a risk that a resin scraped from the accommodation bag B1 by the protrusion may become a foreign matter mixed in a product.

Note that the second distance D2 may be a length of not less than 60% and not more than 95% of the first distance D1, preferably is a length of not less than 65% and not more than 90% of the first distance D1. This optimizes an amount of an air flowing between the sandwiched portion P1 sandwiched by the sandwiching member 30 and each of the outer ends E1 of the accommodation bag B1. Thus, when the opening B2 of the accommodation bag B1 is sealed, it is possible to effectively reduce wrinkles that occur in the accommodation bag B1.

In addition, not only do the contact surfaces of the sandwiching member 30 to be brought into contact with the accommodation bag B1 be each made of resin as described above, contact surfaces of the contact member 10 to be brought into contact with the accommodation bag B1 also may be each made of resin. Further, contact surfaces of the sealing member 40 to be brought into contact with the accommodation bag B1 also may be each made of resin. That is, at least one selected from the group consisting of the contact member 10, the sandwiching member 30, and the sealing member 40 may have resin contact surfaces to be brought into contact with the accommodation bag B1.

In a case where the contact member 10 has resin contact surfaces to be brought into contact with the accommodation bag B1, the resin contact surfaces of the contact member 10 are brought into contact with the inner surface of the accommodation bag B1. In a case where the sealing member 40 has resin contact surfaces to be brought into contact with the accommodation bag B1, the resin contact surfaces of the sealing member 40 are brought into contact with the outer surface of the accommodation bag B1. This means that the contact surfaces to be brought into contact with the accommodation bag B1 are each made of resin. This makes it possible to prevent breakage of the accommodation bag B1. In particular, the contact member 10 being made of resin prevents metal contamination in the accommodation bag B1, and thus it is possible to keep the polycrystalline silicon material S1 accommodated cleaner.

Further, the second portion 11B of the first jig 11 and the second portion 12B of the second jig 12 may each have so long a length along the Z-axis direction that lower ends of the second portions 11B and 12B are located below the sandwiching member 30. In this case, the second portions 11B and 12B are inserted into spaces, which are illustrated in FIG. 4, between the sandwiched portion P1 and the outer ends E1 of the accommodation bag B1. In a state where the sandwiching member 30 sandwiches the accommodation bag B1, the first driving section 21 and the second driving section 22 move in a positive direction of the Z axis, so that the second portions 11B and 12B move to a position above the sealing area SE. At this time, a distance between the second portions 11B and 12B is maintained. After that, the sealing member 40 seals the sealing area SE.

<Method for Producing Polycrystalline Silicon Material Package>

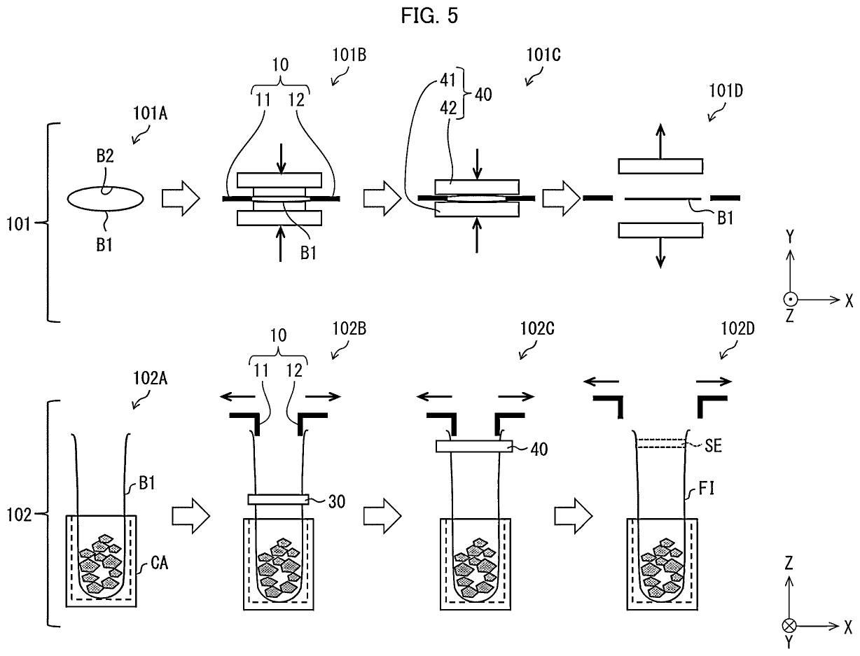

FIG. 5 is a view illustrating a procedure of a method in accordance with Embodiment 1 of the present invention for producing a polycrystalline silicon material package. The reference number 101 of FIG. 5 indicates a view at the time when the accommodation bag B1 is viewed from the positive direction to the negative direction of the Z axis. The reference number 102 of FIG. 5 indicates a view at the time when the accommodation bag B1 is viewed from the negative direction toward a positive direction of the Y axis. In the reference number 101, the accommodation case CA, the polycrystalline silicon material S1, and the driving mechanism 20 are omitted. In the reference number 102, the driving mechanism 20 is omitted.

As illustrated in the reference number 101A and the reference number 102 A, it is assumed that the accommodation bag B1 accommodates the polycrystalline silicon material S1. In this case, as illustrated in the reference number 101B and the reference number 102B, the driving mechanism 20 inserts the contact member 10 from above into the opening B2 of the accommodation bag B1 accommodating the polycrystalline silicon material S1 and brings the contact member 10 into contact with an inner surface of the accommodation bag B1.

Further, in order to flatten the sealing area SE in the accommodation bag B1, the driving mechanism 20 drives the contact member 10 inserted into the opening B2 of the accommodation bag B1 so as to pull at least two points of the opening B2. The sandwiching member 30 sandwiches the accommodation bag B1 at a position below the sealing area SE.

After the sandwiching member 30 has released the accommodation bag B1 from a sandwiched state, the sealing member 40 seals the sealing area SE in the accommodation bag B1, as illustrated in the reference number 101C and the reference number 102C. The accommodation bag B1 in which the polycrystalline silicon material S1 is accommodated and in which the sealing area SE has been sealed is defined as a polycrystalline silicon material package FI. Specifically, the sealing member 40 may seal the sealing area SE within a predetermined period of time after the sandwiching member 30 has released the accommodation bag B1 from the sandwiched state.

According to such a configuration, before the sealing member 40 seals the sealing area SE, the sandwiching member releases the accommodation bag B1 from the sandwiched state. Thus, in the accommodation bag B1, an air present above an area sandwiched by the sandwiching member 30 flows to a position below the area. This makes it possible to reduce wrinkles that occur at the accommodation bag B1.

The first driving section 21 and the second driving section 22 move in the positive direction of the Z axis, so that, as illustrated in the reference number 101D and the reference number 102D, the contact member 10 is lifted, and the sealing member 40 is separated from the accommodation bag B1.

<First Variation>

The first driving section 21 may, instead of moving in the Z-axis direction, cause the second portion 11B to move in the Z-axis direction with respect to the first portion 11A. In addition, the second driving section 22 may, instead of moving in the Z-axis direction, cause the second portion 12B to move in the Z-axis direction with respect to the first portion 12A.

In this case, the first driving section 21 causes the second portion 11B to move in the negative direction of the Z axis while the second driving section 22 causes the second portion 12B to move in the negative direction of the Z axis, so that the second portions 11B and 12B are inserted into the opening B2. In addition, the first driving section 21 causes the second portion 11B to move in the positive direction of the Z axis while the second driving section 22 causes the second portion 12B to move in the positive direction of the Z axis, so that the second portions 11B and 12B move to positions above the sealing area SE.

<Second Variation>

Before the second portions 11B and 12B are inserted into the opening B2, the second portions 11B and 12B may be located apart from each other at an approximate center of the opening B2 in the X-axis direction. In this state, the first driving section 21 moves in the negative direction of the Z axis, so that the second portion 11B also moves in the negative direction of the Z axis to be inserted into the opening B2. In addition, the second driving section 22 moves in the negative direction of the Z axis, so that the second portion 12B also moves in the negative direction of the Z axis to be inserted into the opening B2.

<Third Variation>

Before the second portions 11B and 12B are inserted into the opening B2, the second portions 11B and 12B may be located at a position shifted in the positive direction or negative direction of the X axis from an approximate center of the opening B2 in the X-axis direction and may be in contact with each other. In this state, the second portion 11B moves in the negative direction of the Z axis to be inserted into the opening B2 while the second portion 12B moves in the negative direction of the Z axis to be inserted into the opening B2.

Further, the first driving section 21 causes the first portion 11A to move in the negative direction of the X axis, so that the second portion 11B is brought into contact with one end of the opening B2. The second driving section 22 causes the first portion 12A to move in the positive direction of the X axis, so that the second portion 12B is brought into contact with the other end of the opening B2. At this time, the first driving section 21 and the second driving section 22 adjust respective speeds at which the first portions 11A and 12A are caused to move in the X-axis direction so that at the same time as the second portion 11B is brought into contact with the one end of the opening B2, the second portion 12B is brought into contact with the other end of the opening B2.

Note that, in the third variation, before the second portions 11B and 12B are inserted into the opening B2, the second portions 11B and 12B may be located apart from each other at respective positions each shifted in the positive direction or negative direction of the X axis from the approximate center of the opening B2 in the X-axis direction.

### Embodiment 2

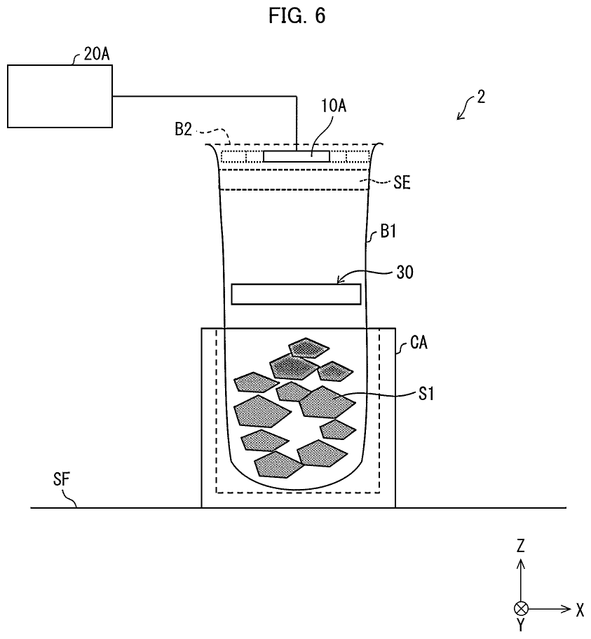

The following will describe Embodiment 2 of the present invention. Note that, for convenience of explanation, members identical in function to those described in Embodiment 1 are given identical reference numerals, and descriptions of such members are omitted. FIG. 6 is a front view illustrating a configuration of a sealing device 2 in accordance with Embodiment 2 of the present invention. A production apparatus 100 may include the sealing device 2 instead of the sealing device 1.

As illustrated in FIG. 6, the sealing device 2 differs from the sealing device 1 in that the contact member 10 and the driving mechanism 20 are changed to a contact member 10A and a driving mechanism 20A, respectively. The contact member 10A is a single member that can extend and contract in an X-axis direction. The contact member 10A is configured to be inserted from above into an opening B2 of an accommodation bag B1 accommodating a polycrystalline silicon material S1 and is configured to be brought into contact with an inner surface of the accommodation bag B1.

The driving mechanism 20A is electrically connected to the contact member 10A and transmits a control signal to the contact member 10A so as to cause the contact member 10A to extend or contract. The driving mechanism 20A drives the contact member 10A inserted into the opening B2 of the accommodation bag B1 so as to cause the contact member 10A to extend, so that the contact member 10A is driven so as to pull at least two points of the opening B2 in order to flatten a sealing area SE in the opening B2.

Aspects of the present invention can also be expressed as follows:

A sealing device in accordance with an aspect of the present invention for a polycrystalline silicon material accommodation bag includes: a contact member configured to be inserted from above into an opening of an accommodation bag accommodating a polycrystalline silicon material and configured to be brought into contact with an inner surface of the accommodation bag; a sealing member configured to seal a sealing area in the accommodation bag; a driving mechanism configured to drive the contact member inserted into the opening of the accommodation bag so as to pull at least two points of the opening in order to flatten the sealing area; and a sandwiching member configured to sandwich the accommodation bag at a position below the sealing area and configured to be able to sandwich the accommodation bag for a second distance shorter than a first distance that is a length of the accommodation bag along the opening of the accommodation bag in which the sealing area has been flattened by the driving mechanism.

According to the above configuration, since the length (second distance) for which the sandwiching member sandwiches the accommodation bag is shorter than the length (first distance) of the accommodation bag along the opening of the accommodation bag, it is possible to allow an air to flow between a portion sandwiched by the sandwiching member and each of outer ends of the accommodation bag in a state where the sandwiching member sandwiches the accommodation bag. Thus, when the opening of the accommodation bag is sealed, it is possible to reduce wrinkles that occur in the accommodation bag.

The contact member may include a first jig and a second jig; the first jig and the second jig may be each configured to be inserted from above into the opening of the accommodation bag and may be each configured to be brought into contact with an inner surface of the accommodation bag; and the driving mechanism may be configured to flatten the sealing area by causing the first jig and the second jig to move apart from each other so as to pull both ends of the opening. According to the above configuration, it is possible to flatten the sealing area with a simple configuration of causing the first jig and the second jig to move. Thus, it is possible to reduce a cost of the sealing device.

The sealing member may be configured to seal the sealing area within a predetermined period of time after the sandwiching member has released the accommodation bag from a sandwiched state. According to the above configuration, the sandwiching member releases the accommodation bag from a sandwiched state before the sealing member seals the sealing area. This allows, in the accommodation bag, an air present above an area sandwiched by the sandwiching member to flow to a position below the area. Thus, it is possible to reduce wrinkles that occur in the accommodation bag.

The second distance may be a length of not less than 60% and not more than 95% of the first distance. The above configuration optimizes an amount of an air flowing between a portion sandwiched by the sandwiching member and each of outer ends of the accommodation bag, so that, when the opening of the accommodation bag is sealed, it is possible to effectively reduce wrinkles that occur in the accommodation bag.

At least one selected from the group consisting of the contact member, the sealing member, and the sandwiching member may have resin contact surfaces to be brought into contact with the accommodation bag. According to the above configuration, the contact surfaces to be brought into contact with the accommodation bag are each made of resin, and thus it is possible to prevent breakage of the accommodation bag. In particular, the contact member being made of resin prevents metal contamination in the accommodation bag, and thus it is possible to keep the polycrystalline silicon material accommodated cleaner.

An apparatus which is for producing a polycrystalline silicon material package and which is in accordance with an aspect of the present invention may include: the sealing device; a carry-in section configured to carry in, to the sealing device, an accommodation bag accommodating a polycrystalline silicon material; and a discharge section configured to discharge, as a polycrystalline silicon material package, the accommodation bag that has been sealed by the sealing device.

A method which is for producing a polycrystalline silicon material package and which is in accordance with an aspect of the present invention includes the steps of: inserting a contact member from above into an opening of an accommodation bag accommodating a polycrystalline silicon material and bringing the contact member into contact with an inner surface of the accommodation bag; driving the contact member inserted into the opening of the accommodation bag so as to pull at least two points of the opening in order to flatten a sealing area in the accommodation bag; sandwiching, with use of a sandwiching member, the accommodation bag at a position below the sealing area in the accommodation bag and for a second distance shorter than a first distance that is a length of the accommodation bag along the opening of the accommodation bag in which the sealing area has been flattened in the step of driving; and sealing the sealing area to make the accommodation bag into a package of the polycrystalline silicon material from.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 2 Sealing device
10A Contact member
11 First jig
12 Second jig
20, 20A Driving mechanism
30 Sandwiching member
40 Sealing member
100 Production apparatus
B1 Accommodation bag
B2 Opening
C1 Conveyor (carry-in section)
C2 Conveyor (discharge section)
CF1 First contact surface (contact surface)
CF2 Second contact surface (contact surface)
D1 First distance
D2 Second distance
FI Polycrystalline silicon material package
S1 Polycrystalline silicon material
SE Sealing area

1. A sealing device for a polycrystalline silicon material accommodation bag, the device comprising:
a contact member configured to be inserted from above into an opening of an accommodation bag accommodating a polycrystalline silicon material and configured to be brought into contact with an inner surface of the accommodation bag;
a sealing member configured to seal a sealing area in the accommodation bag;
a driving mechanism configured to drive the contact member inserted into the opening of the accommodation bag so as to pull at least two points of the opening in order to flatten the sealing area; and
a sandwiching member configured to sandwich the accommodation bag at a position below the sealing area and configured to be able to sandwich the accommodation bag for a second distance shorter than a first distance that is a length of the accommodation bag along the opening of the accommodation bag in which the sealing area has been flattened by the driving mechanism.

2. The sealing device according to claim 1, wherein:
the contact member includes a first jig and a second jig;
the first jig and the second jig are each configured to be inserted from above into the opening of the accommodation bag and are each configured to be brought into contact with an inner surface of the accommodation bag; and
the driving mechanism is configured to flatten the sealing area by causing the first jig and the second jig to move apart from each other so as to pull both ends of the opening.

3. The sealing device according to claim 1, wherein the sealing member is configured to seal the sealing area within a predetermined period of time after the sandwiching member has released the accommodation bag from a sandwiched state.

4. The sealing device according to claim 1, wherein the second distance is a length of not less than 60% and not more than 95% of the first distance.

5. The sealing device according to claim 1, wherein at least one selected from the group consisting of the contact member, the sealing member, and the sandwiching member has resin contact surfaces to be brought into contact with the accommodation bag.

6. An apparatus for producing a polycrystalline silicon material package, the apparatus comprising:
the sealing device according to claim 1; a carry-in section configured to carry in, to the sealing device, an accommodation bag accommodating a polycrystalline silicon material; and
a discharge section configured to discharge, as a polycrystalline silicon material package, the accommodation bag that has been sealed by the sealing device.

7. A method for producing a polycrystalline silicon material package, the method comprising the steps of:
inserting a contact member from above into an opening of an accommodation bag accommodating a polycrystalline silicon material and bringing the contact member into contact with an inner surface of the accommodation bag;
driving the contact member inserted into the opening of the accommodation bag so as to pull at least two points of the opening in order to flatten a sealing area in the accommodation bag;
sandwiching, with use of a sandwiching member, the accommodation bag at a position below the sealing area in the accommodation bag and for a second distance shorter than a first distance that is a length of the accommodation bag along the opening of the accommodation bag in which the sealing area has been flattened in the step of driving; and
sealing the sealing area to make the accommodation bag into a package of the polycrystalline silicon material.
